(19) United States
(12) Patent Application Publication
(10) Pub. No.: US 2006/0057440 A1
(43) Pub. Date: Mar. 16, 2006

(54) Fuel cells and methods for generating electricity

(76) Inventors: Arne W. Ballantine, Round Lake, NY (US); Michael D. Gasda, Albany, NY (US); James F. McElroy, Suffield, CT (US)

Correspondence Address: HESLIN ROTHENBERG FARLEY & MESITI PC, 5 COLUMBIA CIRCLE, ALBANY, NY, 12203, US

(21) Appl. No.: 10/941,044

(22) Filed: Sep. 14, 2004

(51) Int. Cl. H01M 8/10; H01M 2/08

(52) U.S. Cl. 429/13; 429/30; 429/35

(57) ABSTRACT

Fuel cells include a proton conducting medium, and a nonporous hydrogen permeable anode electrode and/or nonporous hydrogen permeable cathode electrode. For example, the electrodes may be a solid thin metallic film such as palladium or a palladium alloy such as a palladium-copper alloy that allow for hydrogen permeation but not impurities. The proton conducting medium may be a solid anhydrous proton conducting medium disposed between the anode electrode and the cathode electrode. The anode electrode and the cathode electrode may be directly sealed to at least one of the proton conducting medium, a first member for distributing a supply of fuel to the anode electrode, a second member for distributing a supply of oxidant to the cathode electrode, and a gasket disposed around the proton conducting medium.

### FIELD OF THE INVENTION

This invention relates generally to hydrogen-based energy system, and more particularly, to fuel cells and methods for generating electricity.

### BACKGROUND OF THE INVENTION

Fuel cells electrochemically convert reactants, for example, a fuel and an oxidant, to electricity. A proton conducting medium permits the passage of protons (i.e., H+ ions) from the “anode” side of a fuel cell to the “cathode” side of the fuel cell while preventing passage therethrough of the reactants (e.g., hydrogen and air/oxygen).

Typically, the proton conducting medium is sandwiched between and in contact with an anode electrode and a cathode electrode made of porous, electrically conducting sheet material. The electrodes are typically made from carbon fiber paper or cloth. In addition, at the interface of the electrode and membrane, i.e., sandwiched therebetween, is a platinum-based catalyst layer to facilitate the electrochemical reaction. Two electrically conductive graphite plates which have one or more reactant flow passages impressed on the surface direct the flow of the reactants to the electrodes.

There is a need for further improvements fuel cells and methods for generating electricity.

### SUMMARY OF THE INVENTION

The present invention provides in a first aspect, devices for generating electricity in which the devices include an anode electrode, a cathode electrode, a first member for distributing a supply of fuel to the anode electrode from an anode inlet, a second member for distributing a supply of oxidant to the cathode electrode, a solid anhydrous proton conducting medium disposed between the anode electrode and the cathode electrode, and wherein the at least one of the anode electrode and the cathode electrode comprises a nonporous hydrogen permeable electrode.

The present invention provides in a second aspect, devices for generating electricity in which the devices include an anode electrode, a cathode electrode, a first member for distributing a supply of fuel to the anode electrode from an anode inlet, a second member for distributing a supply of oxidant to the cathode electrode, a proton conducting medium disposed between the anode electrode and the cathode electrode, and wherein at least one of a) the cathode electrode comprises a nonporous hydrogen permeable electrode and b) the anode electrode and the cathode electrode comprise nonporous hydrogen permeable electrodes.

The present invention provides in a third aspect, devices for generating electricity in which the devices include an anode electrode, a cathode electrode, a first member for distributing a supply of fuel to the anode electrode from an anode inlet, a second member for distributing a supply of oxidant to the cathode electrode, a proton conducting medium disposed between the anode electrode and the cathode electrode, and wherein at least one of the anode electrode and the cathode electrode comprises a nonporous hydrogen permeable electrode and wherein the at least one nonporous hydrogen permeable electrode is directly sealed to at least one of a) the proton conducting medium, b) the first member, c) the second member, and d) a gasket disposed around the proton conducting medium.

The present invention provides in a fourth aspect, methods for generating electricity which include providing a supply of fuel and a supply of oxidant to the above-mentioned devices, and applying an electrical load across the anode electrode and the cathode electrode.

The present invention provides in a fifth aspect, methods for forming a fuel cell in which the methods include providing a proton conducting medium, positioning the proton conducting medium between the anode electrode and the cathode electrode, the anode electrode and/or the cathode electrode comprising a nonporous hydrogen permeable electrode, disposing the anode electrode and the cathode electrode between a first member for distributing a supply of fuel to the anode electrode from an anode inlet, and a second member for supply of oxidant to the cathode electrode, and wherein the positioning and the disposing comprises directly sealing the at least one nonporous hydrogen permeable electrode to at least one of a) the proton conducting medium, b) the first member, c) the second member, and d) a gasket disposed around the proton conducting medium.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is a diagrammatic illustration of a system for generating electricity in accordance with the present invention;

FIG. 2 is a cross-sectional view of one embodiment of a fuel cell which includes a nonporous hydrogen permeable cathode electrode in accordance with the present invention for use in FIG. 1;

FIG. 3 is a cross-sectional view of another embodiment of a fuel cell which includes a nonporous hydrogen permeable anode electrode and a nonporous hydrogen permeable cathode electrode in accordance with the present invention for use in FIG. 1;

FIG. 4 is a cross-sectional view of another embodiment of a fuel cell which includes a nonporous hydrogen permeable anode electrode in accordance with the present invention for use in FIG. 1; and

FIG. 5 is a cross-sectional view of a seal formed between two nonporous hydrogen permeable electrodes in accordance with the present invention.

### DETAILED DESCRIPTION OF THE INVENTION

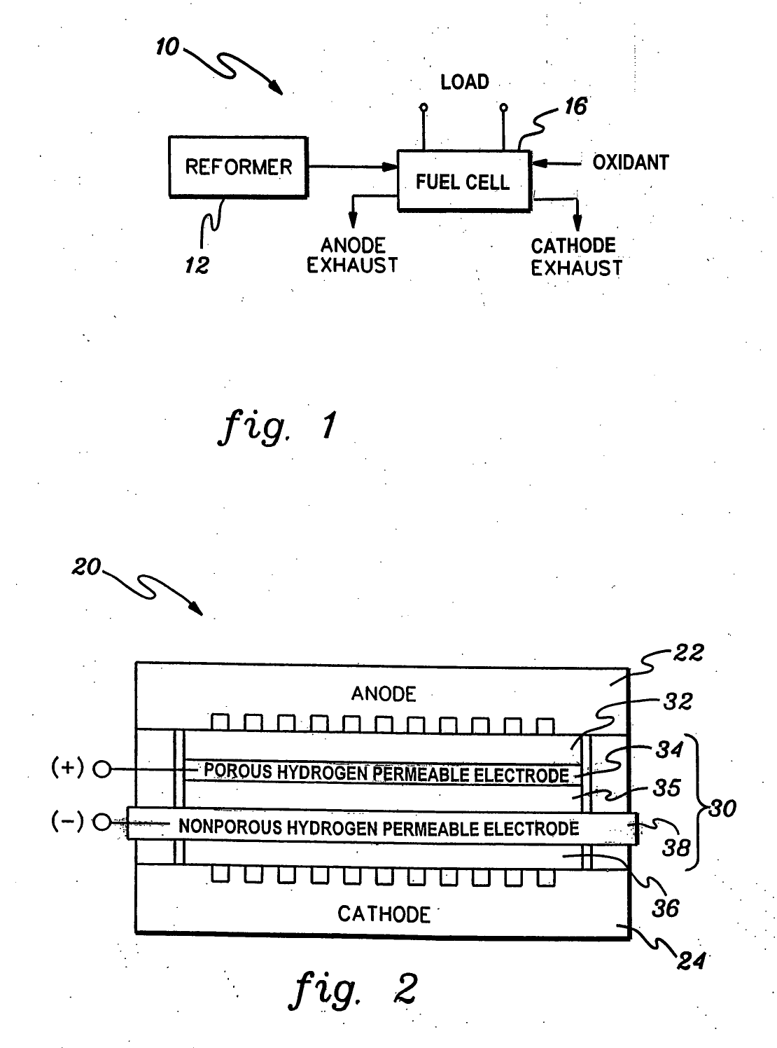

FIG. 1 is an example of one embodiment of a system 10 for generating electricity in accordance with the present invention which may include a reformer 12 such as a catalytic partial oxidation (CPO) reformer, a steam reformer, or an autothermal reformer for converting a hydrocarbon such as methane or methanol into a hydrogen-rich fuel stream, and a fuel cell 16 as described in greater detail below.

The various embodiments of the fuel cell of the present invention may employ a solid anhydrous proton conducting medium (e.g., not having water), and a nonporous hydrogen permeable anode electrode and/or nonporous hydrogen permeable cathode electrode comprising, for example, palladium, a palladium alloy such as a palladium-copper alloy, or other material which allows for hydrogen permeation.

Other embodiments of the fuel cell of the present invention may employ a proton conducting medium disposed between the anode electrode and the cathode electrode wherein at least one of the anode electrode and the cathode electrode comprises a nonporous hydrogen permeable electrode, and wherein the at least one nonporous hydrogen permeable electrode is directly sealed to at least one of the proton conducting medium, a first member for distributing a supply of fuel to the anode electrode, a second member for distributing a supply of oxidant to the cathode electrode, and a gasket disposed around the proton conducting medium. This provides the advantage of sealing and reducing leakage and/or providing a rigid support for the proton conducting medium.

The various embodiments are capable of generating electricity. In addition, the various embodiments of the present invention overcome the problem with conventional fuel cells, which allow impurities such as nitrogen, argon, carbon dioxide, and carbon monoxide to enter the proton conducting medium and/or cross the proton conducting medium.

FIG. 2 illustrates one embodiment of a fuel cell 20 in accordance with the present invention for use, for example, in the system for generating electricity shown in FIG. 1. In this embodiment, as explained in greater detail below, the fuel cell includes a proton conducting electrochemical cell having a nonporous hydrogen permeable cathode electrode.

For example, fuel cell 20 is operable for generating electricity from a supply of fuel containing hydrogen such as reformate and a supply of oxidant such as air. Fuel cell 20 may include an anode separator plate or member 22 attached to an anode inlet for receiving the supply of fuel and having flow channels for distributing the supply of fuel, a cathode separator plate or member 24 connected to a cathode inlet for receiving the supply of oxidant and having flow channels for distributing the supply of oxidant, and a proton conducting electrochemical cell 30 sandwiched between the anode separator plate 22 and cathode separate plate 24.

Proton conducting electrochemical cell 30 may include an anode gas diffusion layer 32 and an anode electrode 34 disposed adjacent to anode separator plate 22, a cathode gas diffusion layer 36 and a cathode electrode 38 disposed adjacent to the cathode separator plate 24, and a proton conducting medium 35 disposed between anode electrode 34 and cathode electrode 38.

Anode electrode 34 may comprise a conventional porous electrode formed from palladium having a plurality of pathways or pores through which protons (H+) and impurities may readily pass. For example, the conventional anode electrode may also comprise platinum or a platinum-ruthenium alloy catalyst layer.

Cathode electrode 38 may include a nonporous hydrogen permeable electrode such as a solid thin metallic film. The solid thin film may include palladium or an alloy comprising palladium such as a palladium-copper alloy, e.g., 60% Cu/40% Pd (atomic percent). The solid thin film electrode may have a thickness less than about 25 microns, and desirably a thickness less than about 10 microns.

In one aspect of the present invention, the proton conducting medium 35 may include solid anhydrous (e.g., not having water) proton conducting mediums, for example, solid state conductors such as inorganic and ceramic based systems, perovskite ceramics, solid-acids such as cesium dihydrogen phosphate (CsH₂PO₄), or other suitable solid anhydrous proton conducting mediums.

In other aspects of the invention, the proton conducting medium 35 may include a proton exchange membrane (PEM) such as a NAFION perfluorosulfonic acid polymer membrane (available from E. I. DuPont de Nemours and Co., Wilmington, Del., USA), a polybenzimidazole (PBI) polymer membrane, a polyetheretherketones (PEEK), sulfonated polysulfones, a polyimide, a hydrocarbon membrane, a polytrifluoro-styrenesulfonic acid, variations of perfluorosulfonic acid membranes, other polymeric or non-polymeric proton conductors including any strong acids.

When the proton conducting electrochemical cell is operated in a fuel cell mode, fuel is supplied to the anode side, oxidant is supplied to the cathode side, and a load is applied to the electrodes. Hydrogen moves from the fuel stream to the porous hydrogen permeable anode electrode where the hydrogen gas forms protons (H+) and electrons. The protons then migrate across the proton conducting medium and conducted through the nonporous hydrogen permeable cathode electrode. The protons are combined with the oxidant and electrons to form water. Impurities and/or the build up of impurities (e.g., CO, N2, etc.) on the anode side are readily exhausted by the anode outlet.

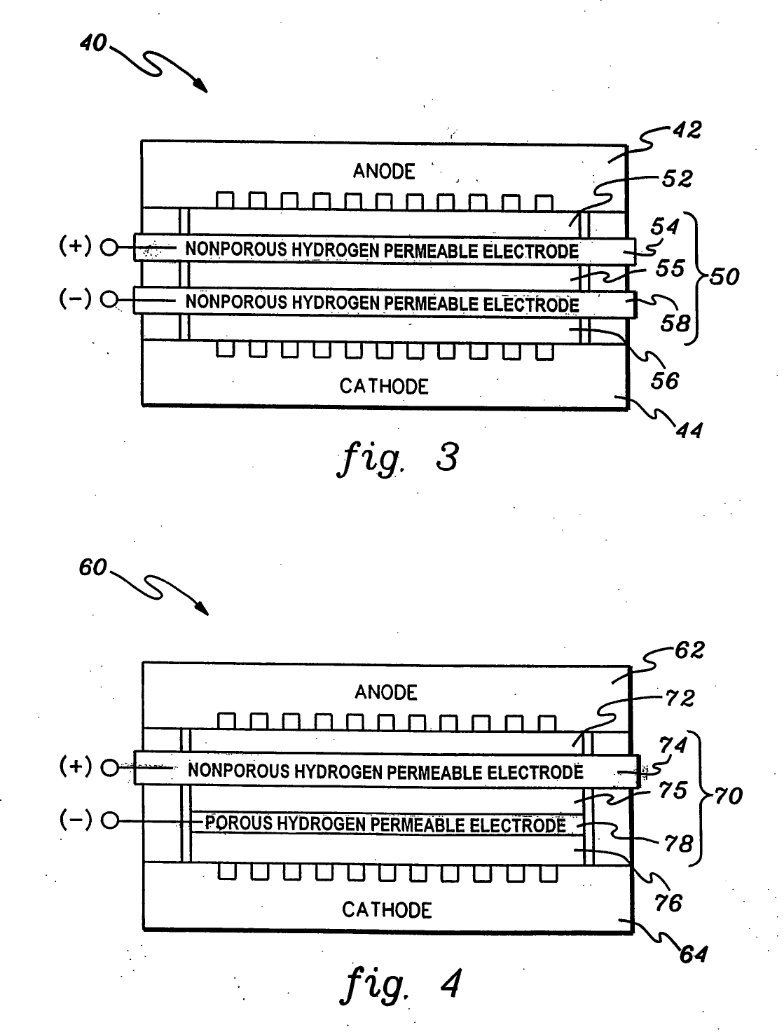

FIG. 3 illustrates another embodiment of a fuel cell 40 in accordance with the present invention for use, for example, in the system shown in FIG. 1. In this embodiment, as explained in greater detail below, the fuel cell includes a proton conducting electrochemical cell having a nonporous hydrogen permeable anode electrode and a nonporous hydrogen permeable cathode electrode.

For example, fuel cell 40 is operable for generating electricity from a supply of fuel containing hydrogen such as reformate and a supply of oxidant such as air. Fuel cell 40 may include an anode separator plate or member 42 connected to an anode inlet for receiving the supply of fuel and having flow channels for distributing the supply of fuel, a cathode separator plate or member 44 connected to a cathode inlet for receiving the supply of oxidant and having flow channels for distributing the supply of oxidant, and a proton conducting electrochemical cell 50 sandwiched between anode separator 42 and cathode separator plate 44.

Proton conducting electrochemical cell 50 may include an anode gas diffusion layer 52 and an anode electrode 54 disposed adjacent to anode separator plate 42, a cathode gas diffusion layer 56 and a cathode electrode 58 disposed adjacent to the cathode separator plate 44, and a proton conducting medium 55 disposed between anode electrode 54 and cathode electrode 58. Anode electrode 54 may comprises a nonporous hydrogen permeable electrode and cathode electrode 58 may comprise a nonporous hydrogen permeable electrode.

Both the nonporous hydrogen permeable anode electrode 54 and the nonporous hydrogen permeable cathode electrode 58 may comprise a solid thin metallic film. The solid thin film may include palladium or an alloy comprising palladium such as a palladium-copper alloy, e.g., 60% Cu/40% Pd (atomic percent). The solid thin may have a thickness less than about 25 microns, and desirably a thickness less than about 10 microns.

The proton conducting medium 55 may include the solid anhydrous proton conducting mediums, and/or other proton conducting mediums as described above in connection with the proton conducting medium in FIG. 2.

When proton conducting electrochemical cell 50 is operated in a fuel cell mode, fuel is supplied to the anode side, oxidant is supplied to the cathode side, and a load is applied to the electrodes. Hydrogen moves from the fuel stream to the nonporous hydrogen permeable anode electrode where the hydrogen gas forms protons (H+) and electrons. The protons then migrate across the proton conducting medium and conducted through the nonporous hydrogen permeable cathode electrode. The protons are combined with the oxidant and electrons to form water.

Essentially pure hydrogen passes through the nonporous hydrogen permeable anode electrode, thereby blocking impurities from passing into the proton conducting medium. Impurities and/or the build up of impurities (e.g., CO, N2, etc.) on the anode side are readily exhausted by the anode. In addition, where the proton conducting medium includes water and other constituents, the water or other constituents in the proton conducting medium will not be allowed to exit the proton conducting medium through back-diffusion, or through carry-over into the product stream or out the inlet since again, essentially just pure hydrogen can pass through the nonporous hydrogen permeable electrodes. Thus, water in the proton conducting medium in the case of a PEM (or acid, in the case of PBI PEM) will be encapsulated causing the PEM to be stable at temperatures higher than normal. As described above, the supply of impure hydrogen and/or the build up of impurities (e.g., CO, N2, etc.) in the anode inlet may be exhausted.

FIG. 4 illustrates another embodiment of a fuel cell 60 in accordance with the present invention for use, for example, in the system shown in FIG. 1. In this embodiment, as explained in more detail below, the fuel cell includes a proton conducting electrochemical cell having a nonporous hydrogen permeable anode electrode.

For example, fuel cell 60 is operable for generating electricity from a supply of fuel containing hydrogen such as reformate and a supply of oxidant such as air. Fuel cell 60 may include an anode separator plate or member 62 attached to an anode inlet for receiving the supply of fuel and having flow channels for distributing the supply of fuel, a cathode separator plate or member 64 connected to a cathode inlet for receiving the supply of oxidant and having flow channels for distributing the supply of oxidant, and a proton conducting electrochemical cell 70 sandwiched between the anode separator plate 62 and cathode separate plate 64.

Proton conducting electrochemical cell 70 may include an anode gas diffusion layer 72 and an anode electrode 74 disposed adjacent to anode separator plate 62, a cathode gas diffusion layer 76 and a cathode electrode 78 disposed adjacent to the cathode separator plate 64, and a proton conducting medium 75 disposed between anode electrode 74 and cathode electrode 78. Anode electrode 74 may comprises a nonporous hydrogen permeable electrode and cathode electrode 78 may comprise a porous electrode.

Nonporous hydrogen permeable anode electrode 74 may comprises a solid thin metallic film. The solid thin film may include palladium or an alloy comprising palladium such as a palladium-copper alloy, e.g., 60% Cu/40% Pd (atomic percent). The solid thin may have a thickness less than about 25 microns, and desirably a thickness less than about 10 microns.

Cathode electrode 78 may comprise a conventional porous electrode formed from palladium having a plurality of pathways or pores. For example, the conventional anode electrode may also comprise platinum or a platinum-ruthenium alloy catalyst layer.

The proton conducting medium 75 may include the solid anhydrous proton conducting mediums, and/or other proton conducting mediums as described above in connection with the proton conducting medium in FIG. 2.

When proton conducting electrochemical cell 70 is operated in a fuel cell mode, reactant is supplied to the anode side, oxidant is supplied to the cathode side, and a load is applied to the electrodes. Hydrogen moves from the fuel stream to the nonporous hydrogen permeable anode electrode where the hydrogen gas forms protons (H+) and electrons. The protons then migrate across the proton conducting medium and conducted through the nonporous hydrogen permeable cathode electrode. The protons are combined with the oxidant and electrons to form water.

Essentially pure hydrogen passes through the nonporous hydrogen permeable anode electrode, thereby blocking impurities from passing into the proton conducting medium. The supply of impure hydrogen and/or the build up of impurities (e.g., CO, N2, etc.) may be exhausted via the anode outlet.

Another aspect of the present invention includes directly sealing the anode electrode or cathode electrode to the proton conducting medium, the anode separator plate or member, the cathode separator or member, and/or a gasket disposed around the proton conducting medium.

For example, in the various embodiments the nonporous hydrogen permeable anode electrode and/or the nonporous hydrogen permeable cathode electrode may be bonded (e.g., by diffusion bonding, welding, vapor deposition, and sputtering) to the anode or cathode separator plate or member. In the case of the cathode, this provides the advantage of sealing in the cathode, high-pressure volume making leakage very small and providing rigid support for the proton conducting medium such as a PEM electrolyte.

The surface of the nonporous hydrogen permeable electrode may also be assembled to create a high contact surface area between the proton conducting medium and the nonporous hydrogen permeable electrode. Such a process may be utilized to maximize the conduction of hydrogen from, for example, a PEM to the nonporous hydrogen permeable electrode. Methods such as physical vapor deposition (PVD) of nonporous hydrogen permeable electrode film material may be employed to create a continuous, but highly conformal layer of material are possible. In such a case, the PVD process may be conducted to deposit the nonporous hydrogen permeable electrode layer directly upon the PEM layer. Other processes, such as low-temperature chemical vapor deposition (CVD) or plasma-enhanced chemical vapor deposition (PECVD) processes may also be possible. Further, processes such as chemical mechanical polishing (CMP), or mechanical scoring of the nonporous hydrogen permeable electrode surface may be possible. Methods of direct bonding of PEM films to nonporous hydrogen permeable electrode films may also be utilized.

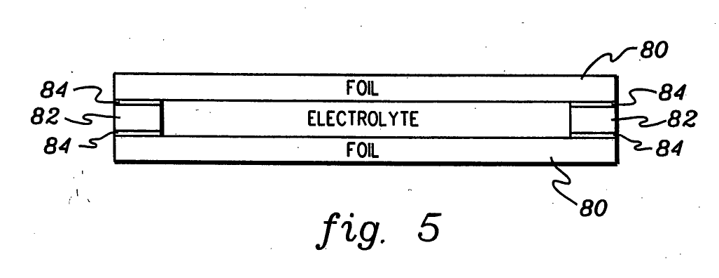

FIG. 5 illustrates one embodiment of a seal formed between two palladium foils 80 for keeping the electrolyte in place. For example, the seal or gasket may be formed using a metallized ceramic 82 which in turn can be diffusion bonded to the palladium foils with a layer of copper 84. In addition, because of the composition of the metallized ceramic, diffusion bonding can take place at the same time the palladium foils are bonded to the end plates. Specifically, a ceramic such as silicon carbide, silicon nitride, aluminum nitride, or a member of a number of ceramics, especially non-oxide ceramics, can be metallized with a multitude of metals, in particular copper. Copper is advantageous in that it will bond to the palladium foil in a similar manner as that of the copper clad end plates.

It is also desirable to maintain a good electrolyte seal, if the electrolyte dehydrates or is otherwise allowed to decompose or leak, cell performance may be diminished. Accordingly, the hydration level may be optimized before sealing in the electrolyte between the nonporous hydrogen permeable electrodes. Additionally, a metallized ceramic gasket may be used, such that the ceramic acts as the dielectric maintaining applied voltage across the cell, and the Pd-alloy nonporous hydrogen permeable electrode is diffusion bonded or welded to the gasket. A hermetic seal is thereby created, and the electrolyte can operate under high pressure without losing seal integrity.

Due to corrosion issues, the nonporous hydrogen permeable electrode and the acid electrolyte may be chosen with care, especially in the case of liquid acid or alkaline electrolytes. The electrode spans a range of electrochemical potentials during normal operation, and the pH will vary as well. Therefore the electrode should be stable throughout the entire resulting area on its Pourbaix diagram. Palladium copper has the advantage of swelling minimally in the presence of hydrogen, and therefore has been shown to have longer usable lifetime, especially through many thermal cycles. Acid electrolytes such as manganic acid, (per)rhenic acid, telluric acid, and technetic acid, may be suitable with PdCu, PdAg, and PdHo.

In the embodiments where the anode electrode comprises a porous electrode and the cathode electrode comprises a nonporous hydrogen permeable electrode, because the palladium cathode electrode allows hydrogen to pass, the cell operated in these modes has the advantages of holding the fluids contained within the proton conducting medium, i.e., the fluids are not allowed to exit the cell as a portion of the product stream.

Additional features of the present invention may include the outer or inner sides (or both sides) of the nonporous hydrogen permeable anode and/or cathode electrodes being coated with platinum, a platinum-ruthenium alloy, palladium, rhodium, noble metals, or other efficient hydrogen reaction catalysts. The layers of compressible conductive material such as gas diffusion media may be introduced between the anode inlet or separator plate and the cathode outlet or separator plate and the proton conducting medium to provide good electrical contact.

When small levels of carbon monoxide are present in an impure hydrogen input stream, the platinum-ruthenium anode catalyst will oxidize the carbon monoxide. Use of air injection of some small concentration may be utilized as well, or the cell temperature may be elevated so that carbon monoxide poisoning is negligible.

In the embodiments where the anode electrode comprises a porous electrode and when a NAFION proton conducting medium is used, input humidity levels may be selected to balance cell performance. For example, since all water must enter and exit the cell via anode inlet and outlet, the cell performance may be optimum when input anode relative humidity (RH) level is less than 100-percent. The advantages of a sealed electrolyte are also apparent with solid-acid electrolytes. Although the proton transport mechanism is anhydrous, these electrodes may still dehydrate. The use of nonporous hydrogen permeable anode and cathode electrodes overcomes this limitation.

In the embodiments where the anode electrode comprises a nonporous hydrogen permeable electrodes (and where the cathode electrode comprises a porous electrode) and where a NAFION proton conducting medium is used, humidification of the electrolyte is alleviated because the necessary water is already present in the membrane material and trapped within the two non porous hydrogen permeable electrodes. In the embodiments where the anode and cathode electrodes comprise nonporous hydrogen permeable electrodes and because the nonporous hydrogen permeable electrodes will prevent water loss from, for example, a NAFION PEM while simultaneously preventing the entry of contaminants, the cell of the invention may be operated at higher temperatures than typically possible with NAFION. Higher equivalent weights of NAFION can also be chosen.

In the embodiments where the anode electrode comprises a porous hydrogen electrode and when a polybenzimidazole (PBI) membrane is used, the cell may be operated at a higher temperature compared to using a NAFION membrane. The nonporous hydrogen permeable cathode electrode acts to prevent evaporative acid loss to the cathode side. Because of the high operating temperature, a polybenzimidazole (PBI) membrane cell will have the advantage of tolerance of high levels of carbon monoxide at the cell anode.

In addition, the various embodiments of the present invention employing a nonporous hydrogen anode electrode and porous cathode, for example, with NAFION as the proton conducting medium, overcome the problem of conventional fuel cells, which produce a product gas stream which is saturated with water at the cell operating temperature.

A non-oxide ceramic may be used in that it is stable in oxidizing and reducing environments, stable in such environments at elevated temperatures (about 1000+ degree Celsius), has a low to zero porosity in fully dense ceramics, exhibit excellent electrical insulator characteristics, and lastly, can be metallized. Methods to metallize ceramic forms are well known and used in the electronics industry on a regular basis in multilayer packages. The sealing material bonds the two foils while at the same time maintaining its electrical insulation character. The sealing mechanism is desirably selected to hold up to the chemical environment as well as the temperatures of the operating cell.

A problem with nonporous hydrogen permeable electrodes for use in fuel cells is corrosion, especially the palladium copper foil which is likely under the hot, high pressure, inside the electrolyte. However, there may be advantages to using incompatible materials for their distinct individual advantages under certain conditions.

Various approaches are proposed which include applying a coating to one or more of the material surfaces, separating or isolating them, and/or treating either or both materials in any other way (e.g., doping, limiting the mass transport of corrosion reaction), in order to enhance the usable lifetime and/or performance of the materials in the context of a fuel cell.

Possible approaches include, for example, the following:
(1) When using bare (uncoated) nonporous hydrogen permeable electrodes, the electrolyte and Pd-alloy may be chosen such that the system is resistant to corrosion throughout the operating space in the Pourbaix diagram for the system.
(2) A layer of porous, catalytically active material such as platinum, palladium, rhodium, or other catalysts may be sputtered onto the surface of one or both nonporous hydrogen permeable electrodes, or applied in some other manner (e.g., PTFE-bonded), such that sufficient electrode area remains to carry out the reaction.
(3) For solid-state proton conductors, the surface of one or both nonporous hydrogen permeable electrodes may be sealed with such material as perovskite ceramic, or solid acid material.
(4) For solid-state proton and electron conductor, similar to (3) above, except the proton conductor is doped with metal to make it electrically conductive as well. A Pd-foil also satisfies these attributes.
(5) For a shorted cell, similar to (4) above, except catalyzed. This is effectively an internally shorted fuel cell/hydrogen pump cell.
(6) Hermetic seal using an electroplated catalyst (e.g., electroplated Pt), similar to (1) above, except non-hydrogen porous. This layer would presumably be quite thin.
(7) For a solid-state, porous proton and electron conductor, similar to (4) above, expect porous.
(8) For an electrode layer (e.g., supported precious metal catalyst with either good “acid management”, or ionomerized), an electrode may be a hydrogen-permeable, catalytically active layer that is electrically and protonically conductive.
(9) For an oxide layer, the layer may be deposited onto the foil. This layer may not necessarily be highly permeable to hydrogen, in which case it must be very thin. Suitable oxides include oxides of tantalum, niobium, vanadium, aluminum, as they readily oxidize in air.

It is also noted that the method, treatment, isolation, or coating of the interface between the electrolyte and a nonporous hydrogen permeable electrode, within an electrochemical system whose purpose is to purify and/or compress hydrogen, may affect hydrogen gas permeability, proton conductor permeability, electron conductor permeability, and whether catalytically active to hydrogen.

The cells may be fabricated using methods employing semiconductor fabrication techniques. For example, a relatively large silicon wafer can be etched with small holes for gas diffusion. A very thin layer (about 100 nm) of palladium can be sputtered onto this structure, and an alloy can be fabricated by co-sputtering its constituents. An optional insulting layer can be applied to prevent shorting against the bottom (cathode) Pd-layer. The electrolyte can be similarly co-sputtered, or applied manually. A final layer of Pd-alloy can applied (where both a nonporous hydrogen permeable anode and cathode electrodes are employed), or simply a catalyzed gas diffusion layer can be applied (where a nonporous hydrogen permeable anode electrode is employed). Current collection from the cathode can be accomplished in a variety of ways, such as edge collection, metal traces through the silicon, or other ways and combinations thereof.

The present invention may be practiced on a wafer-scale embodiment. Such an embodiment would possess the advantage of small size, hundreds of nanometers thick, or even thinner. A very thin electrolyte layer would decrease the resistance and/or electrical losses. In addition, thinner layers may potentially decrease the bulk material costs of a device in mass production.

The device can be constructed using fabrication techniques that may be quite similar to those employed in the semiconductor industry. One such method of fabrication of a wafer-scale fuel cell is proposed below while other methods may be suitable as well.

Beginning with a silicon wafer substrate (or other convenient substrate piece), the wafer is patterned via use of photo-resist, lithography and etched using plasma “RIE” etch to create trenches for passing hydrogen through the substrate. Following this etch processing the photo-resist is then stripped. The trenches may either create holes all the way through the substrate, or the back-side of the substrate may be subsequently thinned where hydrogen passing through is desired such that the holes are exposed to the back-side in the active region.

A conductive path from the front side of the wafer to the back side of the wafer is created. This may be done by heavily doping the Si substrate with P (boron) or N (phosphorous) dopant. This may also be done by coating the trench holes with a conductive material such as a thin conformally deposited layer of Ag, Au, heavily doped Si, or other conductive material. This may also be done by creating additional trenches which will be etched, deposited full of conductor, and polished flat using chemical-mechanical polishing or other such means. If this latter is used, then the processing step to create conductive vias should be carried out prior the wafer being patterned as noted above.

Processing on the backside of the substrate includes a layer of Pd-alloy being sputtered on the backside of the wafer. If it is desired to end-point the etch of the trench-etch steps or by etch-stop with the Pd layer, then this step should be carried out prior thereto. To create the structure of embodiment as shown in FIG. 3, at this point in the processing three layers should be deposited, an anode Pd alloy layer, an electrolyte layer, and a cathode electrolyte layer.

The edges of the Pd layer are then selectively removed. The center region of the wafer Pd layer is protected using photo resist and lithography. The edges of the wafer are etched to remove Pd in that region using plasma or wet etch. Thereafter, the photo resist is removed.

A dielectric spacer is then deposited on the edge of the wafer such as an insulating material such as SiO2, SiₓN_{y} (silicon nitride of sufficient stoichiometry to provide good insulation), ZrO2, or other such material. The edge region is protected using photo resist and lithography. The insulator is etched away in the center region using plasma or wet etch. The end-point of the edge is when the Pd layer is reached. The photo resist is then removed.

The electrode layer is then deposited and etched-back. This includes, protecting the center region using photo resist and lithography, using wet or plasma etch to remove the edge portion of these films, and removing the photo resist.

The present invention results in attaining high purity hydrogen, on a wet basis. For example, conventional NAFION PEM compressors utilizing NAFION 1035 electrolyte have been measured to yield 99.2% pure H2 on a dry basis, but fully saturated at the operating temperature of 65-degrees Celsius, necessitating a subsequent drying step; even then, further purification is necessary in order to achieve the target purity of 99.99%. Compressors utilizing PdCu nonporous hydrogen permeable electrodes yield a hydrogen purity of 99.999% or 99.9999% on a wet basis (no further drying necessary), because palladium alloys will not diffuse gases other than hydrogen.

High pH electrolytes can be difficult to manage in which OH— is charge carrier. For example, the conductivity of the electrolyte is quite high, but this conductivity is a strong function of the water content. This is because of the OH— charge carrier in which water is split at the cathode, and created at the anode. There must be plenty of water available at the cathode to support to the reaction. For example, because PdCu needs to be hot in order to permeate hydrogen (H2), these electrolytes consequently have high vapor pressures. As noted above, the proposed double nonporous hydrogen permeable electrode hydrogen pump, diffusion-bonded to a ceramic gasket, can maintain much higher electrolyte pressures. In addition, the nonporous hydrogen permeable electrode prevents dehydration of a PEM layer.

A PEM or solid-acid electrolyte may not require nonporous hydrogen permeable electrode protection on both sides, since it is solid-state, but this embodiment may be desired for other reasons. For example, the solid acid electrolyte must be protected from liquid water or else it may be dissolved, which could happen in, for example, a cooldown or dormant state. In addition, a cesium dihydrogen phosphate electrolyte, even more than its other solid-acid counterparts (sulfate-, selenate-based acids, e.g.), is particularly vulnerable to dehydration. Even though water is not mobile within this electrolyte, it is necessary to maintain some level of hydration to prevent the material from decomposing at that temperature. It has been shown that the phosphate solid-acid can be kept sufficiently hydrated up to operating temperatures of about 270-degrees Celsius, if a partial pressure of water of about 0.30 atm is maintained (equivalent to a 70-degrees Celsius dewpoint at atmospheric pressure). This pressure is easily maintained within the electrolyte if sealed between nonporous hydrogen permeable electrodes such as PdCu alloy, as compared to thousands of psi if a liquid/water electrolyte is used.

In other aspects of the present invention, the proton conducting electrochemical cells of the present invention may be formed as a flat cell (where the cell has a generally flat shape with top and bottom) or in a tubular shape. The palladium foil example of the molecular sieve material (i.e., electrode) has the advantage that it can be bonded directly to a support, or be used as the support structure itself (e.g., act as a member for distributing or collecting gases), such that a very large differential pressure can be generated and very high pressures achieved.

The present invention may be configured as hydrogen pumps as described in concurrently filed U.S. patent application Ser. No. ______, entitled “Methods, Devices, And Infrastructure Systems For Separating, Removing, Compressing, And Generating Hydrogen” (Attorney Docket No. 2233.003), which is hereby incorporated by reference herein in its entirety. For example, the cathode outlet may be configured as an outlet for exhausting pure hydrogen.

The above-described fuel cells, hydrogen pumps, and proton conducting electrochemical cells in accordance with the present invention may also incorporate additional features. For example, the various embodiments may include a stack or a plurality of proton conducting electrochemical cells, e.g., a matrix of small active area cells run in parallel.

While various embodiments of the present invention have been illustrated and described, it will be appreciated by those skilled in the art that many further changes and modifications may be made thereunto without departing from the spirit and scope of the invention.

1. A method for generating electricity, the method comprising:
providing a supply of fuel and a supply of oxidant to a device comprising:
an anode electrode;
a cathode electrode;
a first member for distributing the supply of fuel to the anode electrode from an anode inlet;
a second member for distributing the supply of oxidant to the cathode electrode;
a solid anhydrous proton conducting medium disposed between the anode electrode and the cathode electrode; and
wherein at least one of the anode electrode and the cathode electrode comprises a nonporous hydrogen permeable electrode; and
applying an electrical load across the anode electrode and the cathode electrode.

2. The method of claim 1 wherein the at least one nonporous hydrogen permeable electrode is directly sealed to at least one of a) the proton conducting medium, b) the first member, c) the second member, and d) a gasket disposed around the proton conducting medium.

3. The method of claim 1 wherein the at least one nonporous hydrogen permeable electrode is directly sealed to the at least one of the first member and the second member by at least one of diffusion bonding, welding, vapor deposition, and sputtering.

4. The method of claim 1 wherein the at least one nonporous hydrogen permeable electrode is directly sealed to the proton conducting medium by vapor deposition.

5. The method of claim 1 wherein the solid anhydrous proton conducting medium is selected from the group comprising a perovskite ceramic and a solid acid proton conducting medium.

6. The method of claim 1 wherein the solid anhydrous proton conducting medium comprises cesium dihydrogen phosphate.

7. The method of claim 1 wherein the anode electrode comprises a nonporous hydrogen permeable electrode.

8. The method of claim 1 wherein the cathode electrode comprises a nonporous hydrogen permeable electrode.

9. The method of claim 1 wherein the anode electrode and the cathode electrode comprise nonporous hydrogen permeable electrodes.

10. The method of claim 1 wherein the providing the supply of reactant comprises a mixture of gas having hydrogen.

11. The method of claim 1 further comprising applying backpressure to the cathode outlet.

12. The method of claim 1 wherein the device comprises a stack.

13. A device for generating electricity, the device comprising:
an anode electrode;
a cathode electrode;
a first member for distributing a supply of fuel to the anode electrode from an anode inlet;
a second member for distributing a supply of oxidant to the cathode electrode;
a solid anhydrous proton conducting medium disposed between the anode electrode and the cathode electrode; and
wherein at least one of the anode electrode and the cathode electrode comprises a nonporous hydrogen permeable electrode.

14. The device of claim 13 wherein the at least one nonporous hydrogen permeable electrode is directly sealed to at least one of a) the proton conducting medium, b) the first member, c) the second member, and d) a gasket disposed around the proton conducting medium.

15. The device of claim 13 wherein the at least one nonporous hydrogen permeable electrode is directly sealed to the at least one of the first member and the second member by at least one of diffusion bonding, welding, vapor deposition, and sputtering.

16. The device of claim 13 wherein the at least one nonporous hydrogen permeable electrode is directly sealed to the proton conducting medium by vapor deposition.

17. The device of claim 13 wherein the solid anhydrous proton conducting medium is selected from the group comprising a perovskite ceramic and a solid acid proton conducting medium.

18. The device of claim 13 wherein the proton conducting medium comprises cesium dihydrogen phosphate

19. The device of claim 13 wherein the anode electrode comprises a nonporous hydrogen permeable electrode.

20. The device of claim 13 wherein the cathode electrode comprises a nonporous hydrogen permeable electrode.

21. The device of claim 13 wherein the anode electrode and the cathode electrode comprise nonporous hydrogen permeable electrodes.

22. The device of claim 13 further comprising a valve for applying backpressure to the cathode outlet.

23. The device of claim 13 wherein the device comprises a stack.

24. A method for generating electricity, the method comprising:
providing a supply of fuel and a supply of oxidant to a device comprising:
an anode electrode;
a cathode electrode;
a first member for distributing the supply of fuel to the anode electrode from an anode inlet;
a second member for distributing the supply of oxidant to the cathode electrode;
a proton conducting medium disposed between the anode electrode and the cathode electrode;
wherein the cathode electrode comprises a nonporous hydrogen permeable electrode; and
applying an electrical load across the anode electrode and the cathode electrode.

25. The method of claim 24 wherein the proton conducting medium comprises a solid anhydrous proton conducting medium.

26. The method of claim 24 wherein the anode electrode and the cathode electrode comprise nonporous hydrogen permeable electrodes.

27. The method of claim 24 wherein the providing the supply of reactant comprises providing a supply of reformate.

28. A device for generating electricity, the device comprising:
an anode electrode;
a cathode electrode;
a first member for distributing a supply of fuel to the anode electrode from an anode inlet;
a second member for distributing a supply of oxidant to the cathode electrode;
a proton conducting medium disposed between the anode electrode and the cathode electrode; and
wherein the cathode electrode comprises a nonporous hydrogen permeable electrode.

29. The device of claim 28 wherein the proton conducting medium comprises a solid anhydrous proton conducting medium.

30. The device of claim 28 wherein the anode electrode and the cathode electrode comprise nonporous hydrogen permeable electrodes.

31. A method for generating electricity, the method comprising:
providing a supply of fuel and a supply of oxidant to a device comprising:
an anode electrode;
a cathode electrode;
a first member for distributing the supply of fuel to the anode electrode from an anode inlet;
a second member for distributing the supply of oxidant to the cathode electrode;
a proton conducting medium disposed between the anode electrode and the cathode electrode; and
wherein at least one of the anode electrode and the cathode electrode comprises a nonporous hydrogen permeable electrode and wherein the at least one nonporous hydrogen permeable electrode is directly sealed to at least one of a) the proton conducting medium, b) the first member, c) the second member, and d) a gasket disposed around the proton conducting medium; and
applying an electrical load across the anode electrode and the cathode electrode.

32. The method of claim 31 wherein the at least one nonporous hydrogen permeable electrode is directly sealed to the at least one of the first member and the second member by at least one of diffusion bonding, welding, vapor deposition, and sputtering.

33. The method of claim 31 wherein the at least one nonporous hydrogen permeable electrode is directly sealed to the proton conducting medium by at least one of vapor deposition and sputtering.

34. The method of claim 31 wherein the proton conducting medium comprises a proton exchange membrane.

35. The method of claim 31 wherein the proton conducting medium is selected from the group comprising perfluorosulfonic acid, polybenzimidazole, perovskite ceramics, and cesium dihydrogen phosphate.

36. The method of claim 31 wherein the anode electrode comprises a nonporous hydrogen permeable electrode.

37. The method of claim 31 wherein the cathode electrode comprises a nonporous hydrogen permeable electrode.

38. The method of claim 31 wherein the anode electrode and the cathode electrode comprise nonporous hydrogen permeable electrodes.

39. The method of claim 31 wherein the providing the supply of reactant comprises providing a mixture of gas having hydrogen.

40. The method of claim 31 further comprising applying backpressure to the cathode outlet.

41. The method of claim 31 wherein the device comprises a stack.

42. A device for generating electricity, the device comprising:
an anode electrode;
a cathode electrode;
a first member for distributing a supply of fuel to the anode electrode from an anode inlet;
a second member for distributing a supply of oxidant to the cathode electrode;
a proton conducting medium disposed between the anode electrode and the cathode electrode; and
wherein at least one of the anode electrode and the cathode electrode comprises a nonporous hydrogen permeable electrode and wherein the at least one nonporous hydrogen permeable electrode is directly sealed to at least one of a) the proton conducting medium, b) the first member, c) the second member, and d) a gasket disposed around the proton conducting medium.

43. The device of claim 42 wherein the electrode is directly sealed to the at least one of the inlet and outlet by at least one of diffusion bonding, welding, vapor deposition, and sputtering.

44. The device of claim 42 wherein the electrode is directly sealed to the proton conducting medium by vapor deposition.

45. The device of claim 42 wherein the proton conducting medium comprises a proton exchange membrane.

46. The device of claim 42 wherein the proton conducting medium is selected from the group comprising perfluorosulfonic acid, polybenzimidazole, perovskite ceramics, and cesium dihydrogen phosphate.

47. The device of claim 42 wherein the anode electrode comprises a nonporous hydrogen permeable electrode.

48. The device of claim 42 wherein the cathode electrode comprises a nonporous hydrogen permeable electrode.

49. The device of claim 42 wherein the anode electrode and the cathode electrode comprise nonporous hydrogen permeable electrodes.

50. The device of claim 42 further comprising a valve for applying backpressure to the cathode outlet.

51. The device of claim 42 wherein the device comprises a stack.

52. A method for forming a fuel cell, the method comprising:
providing a proton conducting medium;
positioning the proton conducting medium between the anode electrode and the cathode electrode, at least one of the anode electrode and the cathode electrode comprising a nonporous hydrogen permeable electrode;
disposing the anode electrode and the cathode electrode between a first member for distributing a supply of fuel to the anode electrode from an anode inlet, and a second member for supply of oxidant to the cathode electrode; and
wherein the positioning and the disposing comprises directly sealing the at least one nonporous hydrogen permeable electrode to at least one of a) the proton conducting medium, b) the first member, c) the second member, and d) a gasket disposed around the proton conducting medium.

53. The method of claim 52 wherein the directly sealing comprises directly sealing the at least one nonporous hydrogen permeable electrode to the proton conducting medium.

54. The method of claim 52 wherein the directly sealing comprises directly sealing the at least one nonporous hydrogen permeable electrode to the first member.

55. The method of claim 52 wherein the directly sealing comprises directly sealing the at least one nonporous hydrogen permeable electrode to the second member.

56. The method of claim 52 wherein the directly sealing comprises at least one of diffusion bonding, welding, vapor deposition, and sputtering, the at least one nonporous hydrogen permeable electrode to at least one of first member and the second member.

57. The method of claim 52 wherein the directly sealing comprises directly sealing the at least one nonporous hydrogen permeable electrode to the gasket disposed around the proton conducting medium.

58. The method of claim 52 wherein the directly sealing comprises directly sealing the at least one nonporous hydrogen permeable electrode to the proton conducting medium by vapor deposition.
